(19) United States
(12) Patent Application Publication
(10) Pub. No.: US 2020/0128234 A1
(43) Pub. Date: Apr. 23, 2020

(54) SUPPORT STRUCTURE FOR A MULTI-TARGET CAMERA CALIBRATION SYSTEM

(71) Applicant: AImotive Kft., Budapest (HU)

(72) Inventors: Kristóf Várszegi, Szentendre (HU); Dániel Rácz, Szeghalom (HU)

(21) Appl. No.: 16/382,623

(22) PCT Filed: Jun. 25, 2018
(86) PCT No.: PCT/HU2018/000028

§ 371 Date: Apr. 12, 2019

(30) Foreign Application Priority Data
Jul. 5, 2017 (HU) U1700127

(51) Int. Cl. H04N 17/00; F16C 11/10; F16M 13/02

(52) U.S. Cl. CPC H04N 17/002; G05D 1/0231; F16M 13/022; F16C 11/106

(57) ABSTRACT

The invention relates to a support structure for a multi-pattern calibration rig, the support structure comprising fastening elements (110) for fixing patterned panels (120) to the support structure, a framework structure (100) consisting of frame segments (101, 102) and joints (103, 104) joining the frame segments (101, 102) to each other, wherein the fastening elements (110) are attached to said frame segments (101, 102) and are adapted for fixing the patterned panels (120) to the framework structure (100) in adjustable orientations.

### TECHNICAL FIELD

The invention relates to a support structure for a multi-pattern calibration rig, the support structure comprising a framework structure and fastening elements for fastening patterned panels to the support structure. A non-limiting example of applying the support structure is camera calibration of a vehicle, and more particularly camera calibration of an autonomous vehicle during assembly.

### BACKGROUND ART

In recent times, camera based applications have gained popularity in numerous fields such as security systems, traffic surveillance, robotics, autonomous vehicles, etc. The camera calibration is imperative in running machine vision-based applications. The camera calibration is a process of obtaining camera parameters to determine (mathematically and accurately) how a three-dimensional (3D) environment is projected onto the camera's two-dimensional (2D) image plane without being affected by any lens distortion. The camera parameters may be, for example, a focal length, a skew, a distortion, etc. Typically, the camera parameters are determined by capturing multiple images of a calibration pattern from different views. The projections of certain key points in the calibration pattern (such as, inner corners in case of a checkerboard pattern) are then detected on the captured images. Then the projected key points of the calibration pattern are used by a conventional camera calibration algorithm for calibrating the camera. There are various mathematical models, for example, an OpenCV pinhole camera model (OpenCV Dev Team, 2016, Camera Calibration and 3D Reconstruction; available at: http://docs.opencv.org/2.4/modules/calib3d/doc/camera_calibration_and_3d_reconstruction.html) for cameras with a narrow field-of-view, a OCam-Calib model (Davide Scaramuzza, 2006, OCamCalib: Omnidirectional Camera Calibration Toolbox for Matlab; available at: https://sites.google.com/site/scarabotix/ocamcalib-toolbox) for catadioptric and fisheye cameras, etc., which use different kinds of camera parameters for camera calibration.

As mentioned above, the most widely used camera calibration methods process images taken from multiple views of a calibration pattern. However, capturing a sequence of such images may take too long and may be too complicated to fit into a mass production factory. Camera calibration algorithms typically require about 10-30 images of a calibration pattern in different orientations. Acquiring multiple images and appropriately repositioning the calibration pattern (or the camera) multiple times after taking a picture is time-consuming, and requires undivided attention of a camera operator. Conventional pattern detection algorithms employ corner detection to locate a calibration object within the captured image. These pattern detection algorithms are designed to detect only a single board containing a particular calibration pattern. Additionally, the detection often fails due to illumination variation and noise present during the image capturing process.

One example of a calibration pattern typically used for calibrating cameras is a checkerboard. Corners and edges of the checkerboard are two most important features. Typical methods used for detecting corners of checkerboards include Harris & Stephens corner detection algorithm, smallest univalue segment assimilating nucleus (SUSAN) corner detection algorithm, X-corner detection algorithm, etc. Hough transformation may be used on the edges to identify a proper set of lines and to locate the checkerboard pattern. Another approach for locating a checkerboard is based on calculating a count of internal holes in an image of a checkerboard for a particular size of the checkerboard. Morphological operations may be applied on the input image for detecting contours and a hierarchical tree is built from the contours. The checkerboard is considered to be correctly identified when a contour having a predetermined number of holes is found. Another widely used calibration pattern is of ellipses, however corners and lines are not present in that case.

Autonomous vehicles operating with minimal human intervention may be used in transporting people and objects. Typically, some autonomous vehicles require an initial input from an operator, while some other designs of the autonomous vehicles are under constant operator control. Some autonomous vehicles can be operated entirely by remote. Conventional autonomous vehicles are equipped with multiple cameras for facilitating control of operation of the autonomous vehicle. Hence, each camera is to be calibrated to ensure reliable and secure operation of the autonomous vehicle.

A multi-target camera calibration system is disclosed in US 2016/0073101 A1. The calibration is achieved by using multiple cameras that capture one or more images of multi-board targets. It is a disadvantage of the known system that the patterned boards can not be adjusted freely according to the current needs and camera types, but their relative orientation is not adjustable.

Thus, the prior art is deficient in a support structure that would improve the adjustability of the patterned panels for camera calibration by allowing a quick and reliable positioning of multiple patterns, especially for autonomous vehicles during assembly in mass manufacturing. The prior art is also deficient in techniques that improve firm fixing of the patterned panels.

### SUMMARY OF THE INVENTION

It is an object of the invention to address and improve the aforementioned deficiencies in the prior art.

It is an object of the invention to provide a support structure for a multi-pattern calibration rig, especially for calibrating at least one camera—e.g. for an autonomous vehicle—by using a multi-pattern calibration rig.

A calibration target comprising multiple patterned panels is preferred. The calibration target is preferably a multi-panel—more exactly a multi-pattern—calibration rig holding the patterned panels. The multi-pattern calibration rig comprises the support structure holding at least two patterned panels. The patterned panels are provided with any kind of repetitive calibration pattern of a calibration shape. Repetitive in this context means that the pattern comprises identical shapes arranged with regular spacings. For example, a patterned panel with a checkerboard pattern may have black or white squares, a patterned panel with a grid of circles may have black or white circles, etc. A camera installed in an autonomous vehicle captures an image of the multi-pattern calibration rig. Hence, multiple patterned panels comprising identical and/or different repetitive calibration patterns are captured in a single input image.

For a preferred application, the camera or cameras to be calibrated are those of an autonomous vehicle, being essentially a car, a truck, any two-wheeled or four-wheeled vehicle, a quadcopter or a drone configured for traffic control, etc. The autonomous vehicle primarily transports people and objects with or without a driver. That is, a self driving car is understood to be an autonomous vehicle. Also a car that is self-driving in some situations, but driven by a human driver in other situations, is understood to be an autonomous vehicle in this context.

The autonomous vehicle may also control traffic congestion, ensure pedestrian safety, detect potholes in a navigation path of the autonomous vehicle, alert the driver on incorrect lane departure and perform many assisting functions to the driver that help him to drive safely and efficiently in accordance with the invention.

The above objects have been achieved by the support structure according to claim 1. Preferred embodiments are described and defined in the dependent claims.

The invention has considerable advantages. The invention enables a single calibration target carrying multiple patterned panels, which can be adjusted freely and firmly according to the given circumstances, e.g. camera types. The support structure is substantially flexible in including multiple calibration patterns in a single field of view of the camera without the need of using multiple calibration targets. Hence, the present invention helps e.g. for automotive manufacturers in reducing production time and minimizing production errors.

A preferred application of the invention is considered to be assembling of an autonomous car on a conveyor belt system of an automotive assembly plant. The autonomous car comprises cameras installed at multiple locations, for example, near headlights or tail lights, near handles of doors, on a roof of the autonomous car, etc. Two multi-pattern calibration rigs may be positioned about 10 meters away from the autonomous car. One multi-pattern calibration rig is positioned facing a front side of the autonomous car, and the other multi-pattern calibration rig is positioned facing a rear side of the autonomous car. While the autonomous car is being assembled on the conveyor belt system, the cameras capture images of the multi-pattern calibration rigs. The invention makes it possible to time-efficiently calibrate the cameras of the autonomous car during the assembling stage, thereby making it suitable to be employed for mass production.

### BRIEF DESCRIPTION OF THE DRAWINGS

In the following, exemplary preferred embodiment of the invention will be described with reference to the drawings, in which

FIG. 1 depicts an embodiment of the support structure of a multi-pattern calibration rig comprising multiple patterned panels;

FIG. 2 depicts an embodiment of a framework structure of the support structure;

FIG. 3 depicts an embodiment of a ball-joint mount of the support structure;

FIG. 4 is a partial view of an embodiment of the support structure with a ball joint mount holding a patterned panel;

FIG. 5 is a schematic view of a camera calibration system, in which the support structures are applied;

FIG. 6 is a screen shot view of a user interface showing the image of the multi-pattern calibration rig comprising the patterned panels; and

FIGS. 7A-7C show different embodiments of applicable calibration patterns.

### MODES FOR CARRYING OUT THE INVENTION

The present disclosure provides a support structure for a multi-pattern calibration rig, the support structure comprising a framework structure and fastening elements for fastening patterned panels to the support structure.

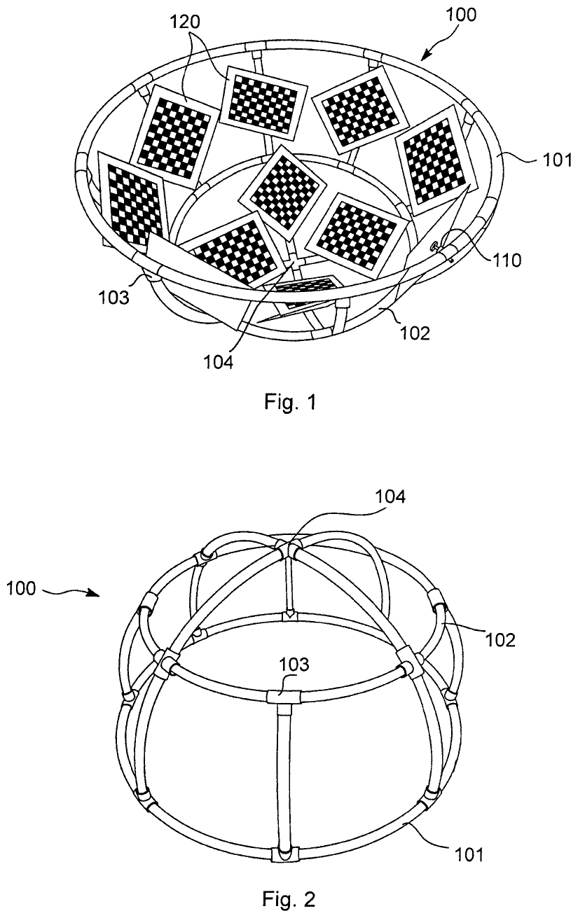

FIG. 1 shows a multi-pattern calibration rig having a support structure, the support structure comprising a framework structure 100 and fastening elements 110 fixing patterned panels 120 to said support structure. The support structure comprises a framework structure 100 consisting of frame segments 101, 102 and joints 103, 104 joining the frame segments 101, 102 to each other, wherein the fastening elements 110 are attached to said frame segments 101, 102 and are adapted for fixing the patterned panels 120 to the framework structure 100 in adjustable orientations.

In the depicted embodiment, the framework structure 100 comprises edge frame segments 101 arranged along a closed shape, and further frame segments 102 being directly or indirectly coupled to the edge frame segments 101 and being arranged along a concave shape. Of course, the framework structure 100 can have any other form, e.g. an umbrella frame-like or a flat framework form, depending on e.g. the actual camera types and distortions.

The support structure is designed to securely hold the patterned panels 120 carrying calibration patterns. In an embodiment, each patterned panel 120 is oriented, positioned on the support structure according to specifications of a camera to be calibrated. The patterned panels 120 may be attached to the support structure in any angle, orientation, etc., by means of agglutination, welding, mounts, etc.

FIG. 2 shows an embodiment of the framework structure 100 of the support structure upside down. In the depicted example, the closed shape of the edge frame segments 101 is circular and the concave shape along which the further frame segments 102 are arranged is a dome shape. Of course, any other closed shape (e.g. polygon) and concave shape (e.g. hemispheric) can be applied.

The framework structure 100 is preferably formed of bent tube segments being attached to each other with joints 103 formed as T-joints and joints 104 formed as cross joints, as shown in the example. The segments can also be made of rods or other profiles, and any suitable joints can be applied, e.g. weldings or clamps.

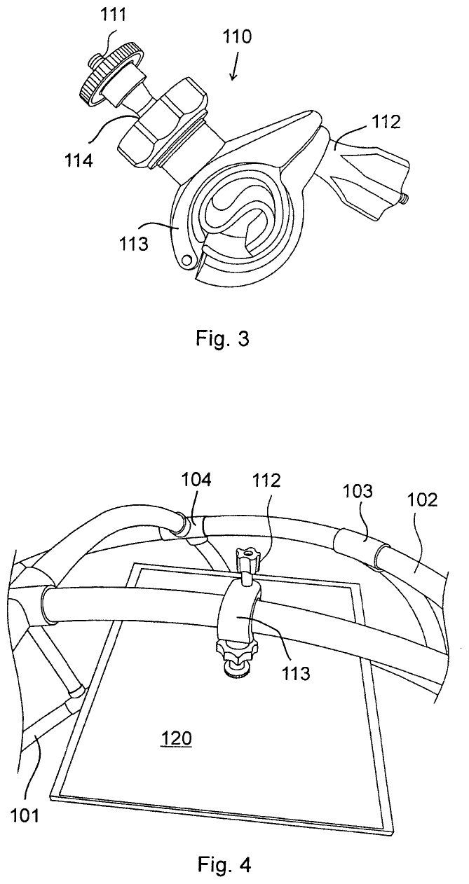

FIG. 3 shows a preferred embodiment of a fastening element 110. The fastening element 110 is preferably a ball joint mount being removably attached to the further frame segments 102 and each having a fastening end 111 adapted for fastening a patterned panel 120 to the support structure. The ball joint mount also comprises a screw clamp 112 having a tightable sleeve 113 for fixing on a further frame segment 102, and a lockable ball joint 114 arranged between the sleeve 113 and the fastening end 111. The fastening end preferably carries a screw joint, but any other fastenings are also conceivable, e.g. gluing or welding. It is conceivable that the fastening elements 110 can also be attached to the edge frame segments 101, if necessary. The fastening elements 110 preferably extend into the interior of the concave shape with their fastening ends 111 and hold the patterned panels 120 at least partly in the interior of the concave shape.

The tightable sleeve 113 and the lockable ball joint 114 may be used for adjusting a 3D orientation of the patterned panels 120.

FIG. 4 shows a partial view of an embodiment of the support structure with a ball joint mount holding a patterned panel 120, in accordance with the invention. The patterned panel 120 is firmly, but removably attached to the support structure by using the fastening element 110 having a ball joint mount. The patterned panel 120 may be attached in any position and/or angle primarily by the adjusting the lockable ball joint 114, and secondarily by the adjusting the tightable sleeve 113.

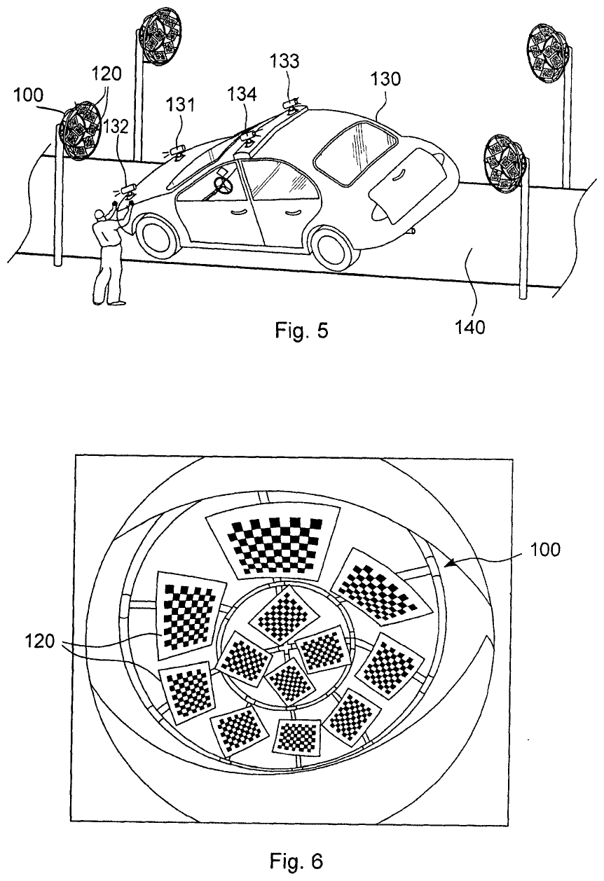

In FIG. 5, as a non-limiting example of using the support structure, calibrating at least one camera of an autonomous vehicle 130 is depicted. The camera calibration comprises four multi-pattern calibration rigs each with a support structure according to the invention, and four cameras 131, 132, 133, 134 installed in or on the autonomous vehicle 130. The multi-pattern calibration rigs comprise multiple patterned panels 120 that are used for calibrating the cameras 131, 132, 133, 134 of the autonomous vehicle 130. In the example shown, the cameras 131, 132, 133, 134 are calibrated while assembling the autonomous vehicle 130 on a conveyor belt 140 in an automotive assembly plant.

The cameras 131, 132, 133, 134 are positioned, for example, on a hood of the autonomous vehicle 130 facing in the direction of movement, and on a roof of the autonomous vehicle 130 facing in a direction opposite to the direction of movement. Each multi-pattern calibration rig is positioned in front of a respective camera 131, 132, 133, 134 of the autonomous vehicle 130, such that the multi-pattern calibration rigs are facing the respective cameras 131, 132, 133, 134 and the patterned panels 120 of the multi-pattern calibration rigs cover a field of view of respective cameras 131, 132, 133, 134.

FIG. 6 shows a screen shot view of a user interface showing the image of the multi-pattern calibration rig comprising the support framework 100 and the patterned panels 120. The cameras 131, 132, 133, 134 to be calibrated capture images of the multi-pattern calibration rigs holding the patterned panels 120. The images are then processed for calibration according to known techniques.

In an example, the multi-pattern calibration rig comprises at least two patterned panels. The patterned panels are provided with a calibration pattern comprising calibration shapes. The calibration pattern is a well-defined repetitive pattern. The calibration shapes may be, for example, squares, circles, ellipses, etc. In an example, the calibration pattern may be a checkerboard pattern comprising black squares or white squares as calibration shapes. In another example, the calibration pattern may be a grid of circles comprising calibration shapes made of circles of a particular shape, a size, or a color.

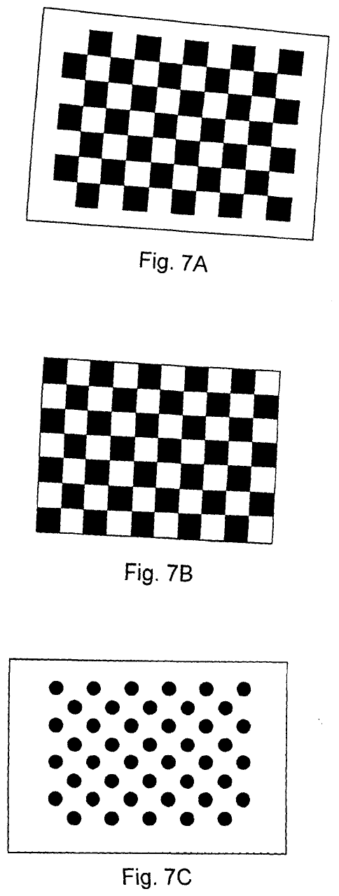

FIGS. 7A-7C demonstrate different embodiments of calibration patterns. Each patterned panel 120 to be attached to a multi-pattern calibration rig is provided with a repetitive calibration pattern. The calibration pattern may be, for example, a checkerboard pattern with black or white squares, a grid of circles comprising black or white circles, etc. As an example, FIG. 7A shows a checkerboard calibration pattern. The calibration pattern comprises black squares as calibration shapes on a white board. In another example, FIG. 7B demonstrates another calibration pattern comprising white squares as calibration shapes on a black board. In another example, FIG. 7C shows another pattern comprising a grid of circles. The calibration pattern comprises black circles as calibration shapes on a white board.

The characteristics of the calibration patterns on the patterned panels 120 are determined based on specifications of the cameras 131, 132, 133, 134 to be calibrated. The patterned panels comprise the calibration patterns that are repetitive in nature, have obvious features, strong contrast, and are easily detectable. The patterned panels may be of any shape or size, for example, square, circle, ellipse, etc. The patterned panels may be made of, for example, wood, plastic, etc.

The invention has been explained in the aforementioned and its considerable advantages have been demonstrated. The invention results in faster calibration of the cameras 131, 132, 133, 134 of the autonomous vehicle 130 during assembly. The calibration of the cameras 131, 132, 133, 134 of the autonomous vehicle 130 by using a single image of the multi-pattern calibration rig comprising multiple patterned panels 120 reduces time required for image acquisition of multiple calibration patterns separately. Thus, as can be seen, a time-efficient and robust camera calibration process can be used for factory applications, in which the patterned panels can be easily adjusted according to the given cameras and/or other parameters.

The invention has been explained above with reference to the aforementioned embodiments. However, it is clear that the invention is not only restricted to these embodiments, but comprises all possible embodiments within the spirit and scope of the inventive thought and the following claims. A multi-pattern calibration rig can consist of more than one support structure, and can carry an arbitrary number of patterns, patterned panels. The invention is suitable for calibrating cameras in any technical application, not only for vehicles.

### LIST OF REFERENCE SIGNS

100 framework structure
101 (edge) frame segments
102 (further) frame segments
103 joints
104 joints
110 fastening elements
111 fastening end
112 screw clamp
113 sleeve
114 lockable ball joint
120 patterned panel
130 vehicle
131 camera
132 camera
133 camera
134 camera
140 conveyor belt

1. A support structure for a multi-pattern calibration rig, the support structure comprising:
fastening elements for fixing patterned panels to the support structure,
a framework structure including frame segments and joints joining the frame segments to each other,
wherein the fastening elements are attached to said frame segments and are adapted for fixing the patterned panels to the framework structure in adjustable orientations.

2. The support structure according to claim 1, wherein the framework structure comprises:
edge frame segments arranged along a closed shape, and
further frame segments being directly or indirectly coupled to the edge frame segments and being arranged along a concave shape.

3. The support structure according to claim 2, wherein the closed shape is circular and the concave shape is a dome shape.

4. The support structure according to claim 2, wherein the fastening elements are ball joint mounts being removably attached to the further frame segments and each having a fastening end adapted for fastening a patterned panel to the support structure.

5. The support structure according to claim 4, wherein the ball joint mount comprises:
a screw clamp having a tightable sleeve for fixing on a further frame segment, and
a lockable ball joint arranged between the sleeve and the fastening end.

6. The support structure according to claim 4, wherein the fastening ends of the fastening elements extend into the interior of the concave shape.

7. The support structure according to claim 1, wherein the framework structure is formed of bent tube segments being attached to each other with joints formed as T-joints and joints formed as cross joints.
